(19) United States
(12) Patent Application Publication
(10) Pub. No.: US 2010/0146260 A1
(43) Pub. Date: Jun. 10, 2010

(54) TANDEM ENCRYPTION CONNECTIONS TO PROVIDE NETWORK TRAFFIC SECURITY METHOD AND APPARATUS

(75) Inventors: ZACHARY LEVOW, MOUNTAIN VIEW, CA (US); DEAN DRAKO, LOS ALTOS, CA (US)

Correspondence Address: PATENTRY, P.O. BOX 151616, SAN RAFAEL, CA, 94915-1616, US

(73) Assignee: BARRACUDA NETWORKS, INC., CAMPBELL, CA (US)

(21) Appl. No.: 12/608,908

(22) Filed: Oct. 29, 2009

Related U.S. Application Data
(63) Continuation of application No. 11/119,566, filed on May 2, 2005.

(51) Int. Cl. H04L 29/06

(52) U.S. Cl. 713/154

(57) ABSTRACT

Security measures are applied to encrypted data exchanges by enabling content decryption, rule application, and content re-encryption at a network location. A certificate, self-signed or authenticated by an official Certificate Authority is obtained for and installed within the secure proxy apparatus. A link to a secure page is replaced with a link to a page having a fully qualified domain name of the proxy apparatus as the suffix. An encrypted session between the client is established between the client and the proxy apparatus without deceit in the later case. A first encryption-enabled connection is established from the first node to a content filter, while a second encryption-enabled connection is established from the content filter to the second node. Following decryption, a determination is made as to whether the content includes Undesired Data. Restricted material is blocked, while unrestricted material is re-encrypted and delivered to the destination node. For a self-signed certificate, the destination node comprises a private security system-signed root certificate installed in the destination node's Trusted Root Certification Authorities certificate store. In another aspect of the invention, at least one of encrypted Instant Messages, e-mail messages and web pages are decrypted and recorded at a location between sources and destinations of the transmissions. The look and feel is maintained of a single encrypted link between the requestor and the external source by the inventive use of a wildcard certificate within the network local to the requestor.

This application is a continuation in part of Ser. No. 11/119,566 inventors Levow, Zachary; and Drako, Dean; filed May 2, 2005. The invention relates generally to providing network security and more particularly to methods and systems for applying security measures to network traffic that includes encrypted transmissions.

### BACKGROUND ART

While the ability to link a business or other organization to the Internet opens the door to a wide range of useful resources, the door is simultaneously open to security breaches. Thus, it is common for an organization to install and manage one or more security systems. For example, firewalls are installed between networks to examine data and determine whether security rules are violated by passage of transmissions through the firewall.

Firewalls may take one or more of a number of different approaches. One known approach is referred to as packet filtering, since data packets are inspected to determine their sources, destinations, and perhaps other information, such as the data type (e.g., video). In the application-level approach for a firewall, network traffic is examined at the application layers, such as an e-mail firewall that screens electronic mail messages. Persons skilled in the art will recognize that other approaches are also available.

In providing Internet security, there are three general categories of concern. There is a “confidentiality concern” in controlling the distribution of the data of an organization. The unwanted distribution of data may be a result of an intrusion into the network or may be a consequence of unauthorized release of information by members of the organization. An “integrity concern” category involves preventing the unauthorized modification of data. Thirdly, an “availability concern” relates to preventing others from rendering the organization's data inaccessible by members of the organization.

Security breaches may take a variety of forms. A virus may destroy data or may overwhelm a network and render data unavailable to the organization. Other forms are less destructive, but are significant. For example, Spyware and Adware will potentially breach confidentiality and will reduce the speed of infected computers. Spam reduces the efficiency of members (e.g., employees) of the organization.

Encryption is one effective tool for providing data security. Data is encrypted (scrambled) prior to transmission and is decrypted at the destination. Thus, any parties eavesdropping on the data transmission are unable to simply read plain text. Instead, an unintended party must determine the necessary steps for decrypting the data. It follows that the effectiveness of the encryption is dependent upon the encryption techniques. A set of instructions (an algorithm) is used to scramble the data, which can then be descrambled using an encryption key. A symmetric key is one that is used by both the source and the destination, while asymmetric keys are used when the source and the destination use keys that are different but mathematically related.

While there are advantages to the use of encryption, the method may be employed intentionally or unintentionally to defeat other network security measures. For example, content filtering is less effective or even useless when the content is encrypted. FIG. 1 illustrates a system in which a client computer 10 is connected to a server 12 via the Internet 14. As one example, the user at the client computer 10 may be engaged in a business transaction that requires interaction with the server. As a preliminary, the client and server may utilize the Secure Sockets Layer (SSL) protocol to establish a secure connection. In the system configuration of FIG. 1, a security system 16 is located between the client and the server, so that the secure connection passes through the security system. While the security system is still able to perform various tasks, content filtering is limited by the use of encryption in the transmissions between the client and server.

U.S. Pat. No. 6,714,982 to McDonough et al. describes a modification of the system configuration shown in FIG. 1. The patent describes a method that includes establishing a first secure network connection through a publicly accessible network (such as the Internet) between a network server and a sender. Additionally, a second secure network connection is established through a publicly accessible network between the server and a recipient. The central server can then determine whether the recipient has an associated account on the network server. If the recipient has an account, messages from the sender will be forwarded to the recipient. Without such an account, the recipient will not receive the messages. The method may be used to provide security for messages such as e-mail, chat, Instant Messaging, and e-commerce. The method provides advantages relative to the single secure connection approach of FIG. 1, but further advances are desired.

U.S. Pat. No. 6,643,701 to Aziz et al. also describes a method in which the traditional single secure connection is divided into separate secure connections. For example, a “relay” may be located between a client and a server, such as the client 10 and server 12 of FIG. 1. The client may provide information to the relay to allow the relay to establish a secure connection between the client and the relay. The relay then creates a second secure connection between itself and the server. Aziz et al. states that there are a number of potential benefits to this arrangement. For example, the information transmitted between the client and the server may be reformatted, if the information is not in the format acceptable to the server. Moreover, the information can be used in testing a process of either the client or the server. Information may be used to test malfunctioning equipment or processes by performing timing measurements, by altering the messages for failure analysis, or by performing other functions needed for problem diagnosis or troubleshooting. Yet another advantage is that the method and system may be used to increase the possible number of new secure connections to the server. Additionally, the relay may perform some processing of the information transmitted between the client and the server.

While the prior art approaches function well for their intended purposes, further advances in the area of providing security are desired.

### SUMMARY OF THE INVENTION

In accordance with one aspect of the invention, security measures are applied to network traffic by enabling content decryption, rule application, and content re-encryption at a network location between two nodes engaged in a secured transaction. A first encryption-enabled connection is established from the first node to a content filter, while a second encryption-enabled connection is established from the content filter to the second node. Following decryption, it is determined whether the content includes Undesired Data. As used herein, “Undesired Data” includes at least one of Spyware, Adware, viruses, or other undesirable content or communications. On the basis of the determinations of whether the content includes Undesired Data, continued transmission is either enabled or restricted, depending upon the security rules being applied. Unrestricted content is re-encrypted for delivery to the appropriate node. As a second aspect of the invention, the method is specific to providing the decryption and re-encryption for the purpose of recording contents of the secure transmissions, such as the contents of Instant Messages, e-mail messages or even encrypted web pages.

The security measures (i.e., policy) may be set on an individual basis or may be specific to groups of individuals, such as defining different policies for various departments of an organization. Thus, some individuals may be limited to exchanges of Instant Messages with others within the organization, while other individuals may be allowed to exchange Instant Messages via the Internet. Similarly, there may be variations in rules regarding access to specific websites accessible by specific individuals.

In one embodiment, the process for establishing the first and second encryption-enabled connections is transparent to the first and second nodes and transparent to users at the nodes. That is, operations by the nodes during the processing for establishing the two encryption-enabled connections are identical to operations for establishing a conventional single end-to-end secure connection. However, in other embodiments, at least one of the nodes performs processing that identifies the end-to-end link as being divided into two encryption-enabled connections. For example, one node may be a client computer intending to enter into a secure transaction with a server via a gateway of an enterprise, wherein the content filtering occurs for transmissions through the gateway.

In an embodiment, a certificate authenticated by an official Certificate Authority is obtained for and installed within the secure proxy apparatus. A link to a secure page is replaced with a link to a page having a fully qualified domain name of the proxy apparatus as the suffix. An encrypted session between the client is established between the client and the proxy apparatus without deceit.

In an embodiment a wildcard certificate is used in providing the secure data exchange. In one embodiment, establishing the first encryption-enabled connection includes offering a self-signed wildcard certificate to the first node, which is a “requester node” in the data exchange. After the first connection is established, the content filter establishes a second encryption-enabled connection to the source node of the requested content. If any certificate issues arise in establishing the second connection, the requester node may be notified. Persons skilled in the art will recognize the operations associated with wildcard certificates in establishing a secure connection (e.g., SSL connection) and will recognize the potential certificate issues which may be a concern. Optionally, to avoid the specific issue that may cause the requester node to generate an error or warning due to the fact that the wildcard certificate has not been signed by an official Certificate Authority (“CA”), the authority certificate may be distributed to potential requesters.

There may be some applications in which it is desirable to avoid decryption and/or inspection of certain content, even when possible. For example, an Internet Service Provider (ISP) may determine that it is inappropriate to scan the contents of banking transactions of users. In this event, it is possible to specify a list of servers, either by network address/range or by a portion, pattern, or exact match of the server name returned by a selected network address-based lookup, such as a reverse DNS lookup. If it is thereby determined that the request should not be decrypted/inspected, the request may be forwarded without the decryption/re-encryption process.

In addition to the transparent mechanism described above, it is possible to perform inspection of encrypted content using a traditional HTTP proxy configuration. Normally, when an HTTP client is configured to proxy HTTPS using a conventional proxy server, the client may request secure data via the proxy server using the “CONNECT” request method. Unfortunately, in such a configuration, the proxy server does not “understand” or interpret the content. It is possible, however, to use the processing described above to perform inspection in such a situation. In this scenario, the client connects to the proxy server (which may or may not be the same device). When the “CONNECT” command is issued, the proxy server directs the request through the transparent gateway and the remainder of the process is as described above. This could also be accomplished by placing the transparent gateway between the proxy server and the requested server.

An advantage of the invention is that Undesired Data can be identified and blocked before reaching a target node, such as a client computer utilized by an employee of an organization. It is not conventional for Spyware to be encrypted, but the invention enables detection if Spyware encryption becomes a practice.

Encryption of Instant Messages is known. In accordance with this second aspect of the invention, Instant Messages are monitored regardless of sources and destinations. In the same manner as detecting Spyware and Adware, separate secure connections may be formed to enable end-to-end security between the sources and the destinations. Any encrypted Instant Messages are decrypted and archived. For a particular organization in which security concerns dictate decisions regarding employee communications, the encrypted Instant Messages may be intercepted and content filtered before being forwarded to the destination computer. Moreover, the contents of encrypted e-mail messages and web pages may be content filtered and/or archived.

### BRIEF DESCRIPTION OF THE DRAWINGS

FIG. 1 is a schematic view of a prior art approach to providing a secure connection between two nodes.

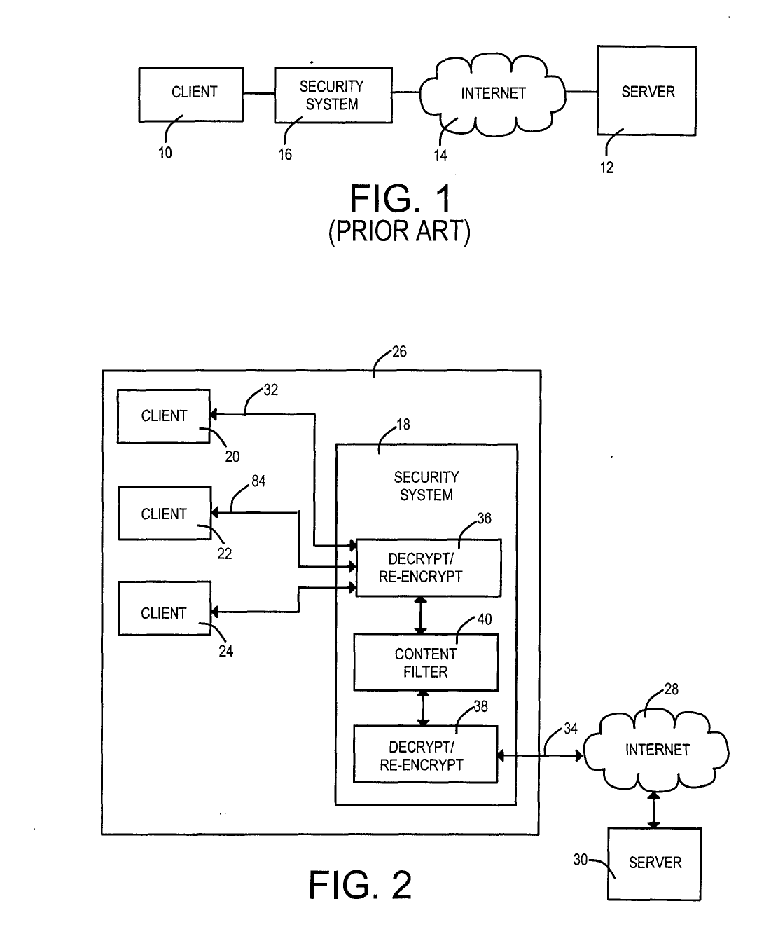

FIG. 2 is a block diagram of a system for providing security for network traffic in accordance with one embodiment of the invention.

FIG. 3 is a block diagram of selected components of the security system of FIG. 2.

FIG. 4A is one embodiment of a process flow of steps for creating, distributing and installing self-signed private security system root certificates and a self-signed private security system wildcard certificate in accordance with the invention. FIG. 4B is one embodiment of a process flow of steps for establishing a divided encryption connection in accordance with the invention.

FIG. 5 is a process flow of steps for applying security measures to network traffic using a self-signed wildcard certificate in accordance with one embodiment of the invention.

### DETAILED DESCRIPTION

An embodiment of the invention comprises an apparatus for filtering content between a client within a local area network and a server coupled to the wide area network known as the Internet, comprising
a first network interface and
a second network interface,
a policy-driven pass through or proxy circuit,
a content filter,
a certificate store,
a webserver circuit,
a encryption/decryption circuit, and
a link replacement circuit,
   wherein the policy-driven pass through or proxy circuit is coupled to the first network interface to receive a client request for a uniform resource locator, and
   wherein the webserver circuit is coupled to the first network interface and to the certificate store whereby a certificate is presented to a client to establish a first encrypted link.

In an embodiment the policy-driven pass through or proxy circuit is controlled by a protocol portion of a requested uniform resource locator (url).

In an embodiment the policy-driven pass through or proxy circuit is controlled by a list of trusted fully qualified domain names of a requested url.

In an embodiment the policy-driven pass through or proxy circuits is controlled by comparison of a list of dangerous fully qualified domain names with a requested url.

In an embodiment the encryption/decryption circuit is coupled to the content filter and to the first network interface and to the second network interface whereby traffic proxied between the first network interface and the second network interface is decrypted, filtered, and re-encrypted for transmission.

An embodiment of the invention is a method for operating the apparatus comprising:
receiving a request from a client containing a request to a secure link,
replacing the text of the requested resource with a request for a secure proxy,
presenting a certificate from a Certificate Authority for the secure proxy,
establishing a first encrypted link between the client and the secure proxy, and
filtering, and re-encrypting the content for transmission if it passes the filter.

An embodiment of the invention is a method for preventing clients in a client server system from bypassing a proxy apparatus comprising: blocking https requests except through the secure proxy, configuring a domain name system server to direct external resource requests to the IP address of the proxy apparatus, and configuring each client browser to prevent users from typing certain links.

An embodiment of the invention is a method for determining if a proxy is interrupting a client server session comprising embedding a javascript program within a webpage to check if links within the webpage have been modified or manipulated.

An embodiment of the invention is a computer implemented method for applying security measures to network traffic comprising:
as a response to an HTTPS (Hypertext Transfer Protocol Secure) request to establish a secure connection between a first node and a second node,
   enabling a secure data exchange between said first node and said second node such that content of said data exchange is encrypted, including
establishing a first encryption-enabled connection from said first node to a content filter and
establishing a second encryption-enabled connection from said content filter to said second node,
   wherein establishing said second encryption-enabled connection includes issuing a request from said content filter to said second node on behalf of said first node;
decrypting content of web-based data received at said content filter via said second encryption-enabled connection;
applying said rules to determine whether said content includes content in violation of said rules;
using said determinations as a basis for enabling or inhibiting continued transmission of said content;
re-encrypting said content for which continued transmission is enabled; and
providing delivery of said re-encrypted content via said first encryption-enabled connection.

In an embodiment the method further comprises:
creating, distributing and installing self-signed private security system root certificates and a self-signed private security system wildcard certificate;
defining rules regarding permissible network transmissions, including enabling some said rules to be specific to individuals to whom said security measures are intended to protect.

In an embodiment the method further comprises:
within the first node, validating the self-signed private security system wildcard certificate with the self-signed private security system root certificate installed in the Trusted Root Certification Authorities certificate store.

In an embodiment, establishing said first and second encryption-enabled connections and decrypting said content are executed in a manner transparent to said first and second nodes, including using a self-signed wildcard certificate in establishing said first encryption-enabled connection.

In an embodiment, said first node is an HTTP client and said second node is a server that is accessed by said client via the global communications network referred to as the Internet.

In an embodiment, at least some said rules are specific to detecting Spyware.

In an embodiment, establishing said first encryption-enabled connection includes offering a private security system-signed wildcard certificate to said first node, said first node being a requester node with respect to said data exchange and being one of a plurality of nodes to which a private security system-signed root certificate had been distributed in anticipation of receiving a wildcard certificate that is unsigned by a third party official Certificate Authority (CA).

In an embodiment the method further comprises identifying certificate issues to said requester node if said certificate issues are detected while establishing said second encryption-enabled connection.

In an embodiment the method further comprises monitoring Instant Messages (IMs) and e-mail messages that are encrypted exchanges, said monitoring including decrypting and re-encrypting said IMs.

In an embodiment the method further comprises recording said IMs and e-mail messages following said decrypting.

In an embodiment said monitoring includes detecting IMs exchanged among computers of a single business.

In an embodiment defining said rules includes establishing an ignore list for selected said network transmissions, said decrypting and re-encrypting being disabled upon determining that a particular said network transmission is consistent with said ignore list.

The present invention comprises a system for providing security for network traffic comprising:
a first input/output (I/O) interface;
a second I/O interface;
means for establishing a first encryption-enabled connection to a network node via said first I/O interface and for establishing a second encryption-enabled connection via said second I/O interface, said means for establishing being configured to utilize private security system-signed wildcard certificates to establish said first encryption-enabled connection and to provide both of said first and second encryption-enabled connections using Secure Sockets Layer protocol;
means for creating, distributing, and installing a private security system-signed Certificate Authority certificate to potential requestor nodes,
whereby a specific issue that may cause the requester node to generate an error or warning due to the fact that the wildcard certificate has not been signed by an official Certificate Authority (“CA”) is avoided,
   a decryptor coupled to said second I/O interface to decrypt HTTP transmissions received via said second I/O interface;
   a content filter operatively associated with said decryptor to filter Undesired Data that includes at least one of Spyware, Adware, viruses, or other undesirable content or communications, and to pass allowed content; and
   a re-encryptor operatively associated with said content as re-encrypted HTTP transmissions filter to re-encrypt said allowed content and to direct said re-encrypted allowed content to said first I/O interface.

In an embodiment said first and second I/O interfaces are merely two of a greater number of such I/O interfaces of said system.

In an embodiment said content filter includes a library of Spyware signatures, each said Spyware signature being specific to an instance of Spyware.

In an embodiment said first and second I/O interfaces are at a gateway of a network.

In an embodiment said content filter is further configured to decrypt Instant Messages, said first and second I/O interfaces being connected within a network to receive said Instant Messages exchanged within said network.

In an embodiment, the system further comprises memory for recording said Instant Messages that have been decrypted.

In an embodiment the present invention comprises a method comprising the steps following:
generating a private security system-signed root certificate as a self-signed “certificate authority; and
creating a private security system-signed wildcard certificate.

In an embodiment the method further comprises distributing the private security system-signed root certificate to at least one client of a security system apparatus.

In an embodiment the method further comprises importing and installing the private security system-signed root certificate into each client's Trusted Root Certification Authorities certificate store.

In an embodiment the method further comprises installing said wildcard certificate in the security system apparatus

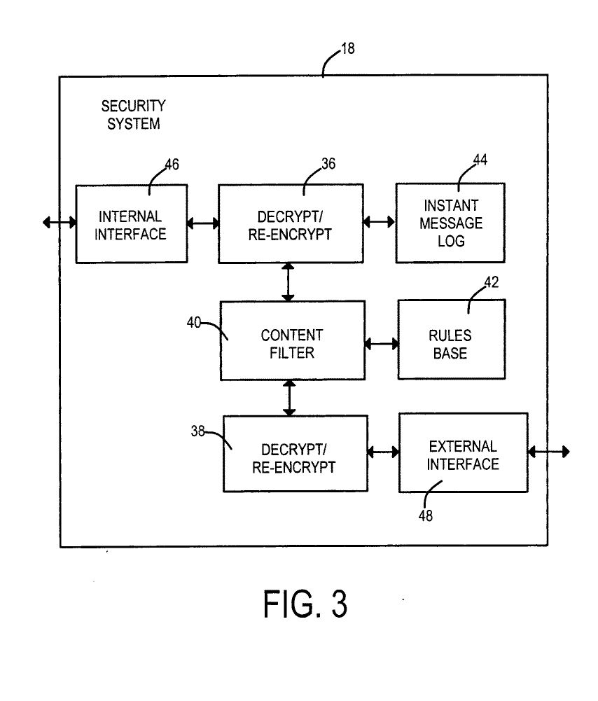

FIG. 2 is a simplified system for providing network security in accordance with one embodiment of the invention. However, additional components are typical and other system configurations are contemplated. A security system 18 is shown as being located within the paths between client computers 20, 22 and 24 of an organization 26 and the global communications network referred to as the Internet 28. The security system may be placed “within the paths” either physically, or through manual/automatic proxy configuration. The organization may be a business enterprise, an educational facility, government entity, etc. Alternatively, the client computers may be more loosely related, such as independent subscribers to an Internet Service Provider (ISP). As another alternative embodiment, the client computers may be other types of nodes which are connected to a network and for which network security is desired. Other system components, such as a gateway, are not shown in FIG. 2, but may be included within a specific embodiment.

Encryption of Spyware is not the typical approach taken by persons intending to load Undesired Data onto the client computers 20, 22 and 24. As used herein, “Spyware” is programming that is loaded onto a user's computer to gather information about the actions of the user and relay the information to interested parties at remote sites or to perform actions on the computer on the basis of information gathered from the user's computer, including actions by the user. The most likely approach taken by Spyware providers to entice computer users to install Spyware is to embed the Undesired Data into a download that is sought for some other reason, such as a free utility. The user may be notified that the download contains Spyware, but only in a lengthy license agreement that is not likely to be read. Adware may be considered to be a type of Spyware or may be viewed separately. “Adware” is defined herein as a program which generates advertisements or other promotional material, often in the form of popup ads and, at times, based upon the actions of or information gathered about the user of the computer.

Spyware exists as independent executable programs, which may monitor keystrokes, scan stored information, read “cookies,” or even change the user-selected preferences of a computer, such as the default homepage of a web browser. In addition to Spyware and Adware, unsolicited programs which may successfully pass through a security system when encrypted include “worms” and “Trojan horses.” The unsolicited programs of concern to this invention are sometimes broadly categorized as “malware,” as a shortened identification of “malicious software.”

In addition to providing security with regard to encrypted Undesired Data, the invention to be described may be used for other purposes. For example, the unauthorized release of information by employees of a company may be monitored, even when an employee uses encryption. Moreover, the invention may be used for providing content filtering and/or archiving of encrypted Instant Messages (IMs), e-mail messages, and/or web pages. As is well known in the art, an IM is a message sent between two users, typically using a dedicated IM application running on a client computer 20, 22 and 24. Unlike e-mail messages exchanged between the client computers, IMs require a current “presence” of the IM application running on both computers.

The present invention prevents encryption from being used to foil the security measures established by the organization 26 or by the user of a stand-alone computer protected by a security system 18 of the type shown in FIG. 2. For example, the stand-alone computer may be protected using a security system at an ISP that enables Internet access by a user at the computer.

The security system 18 functions as a “middleman” with respect to information that is encrypted. Separate encryption-enabled connections are formed to and from the security system. Thus, if the client computer 20 has encryption capability and is to be used to exchange confidential information with a server 30 via the Internet 28, the first encryption-enabled connection is between the client computer and the security system, while the second encryption-enabled connection is from the security system to the server. The connections will be described as being Secure Sockets Layer (SSL) connections, but other protocols may be substituted, such as a Secure HTTP protocol.

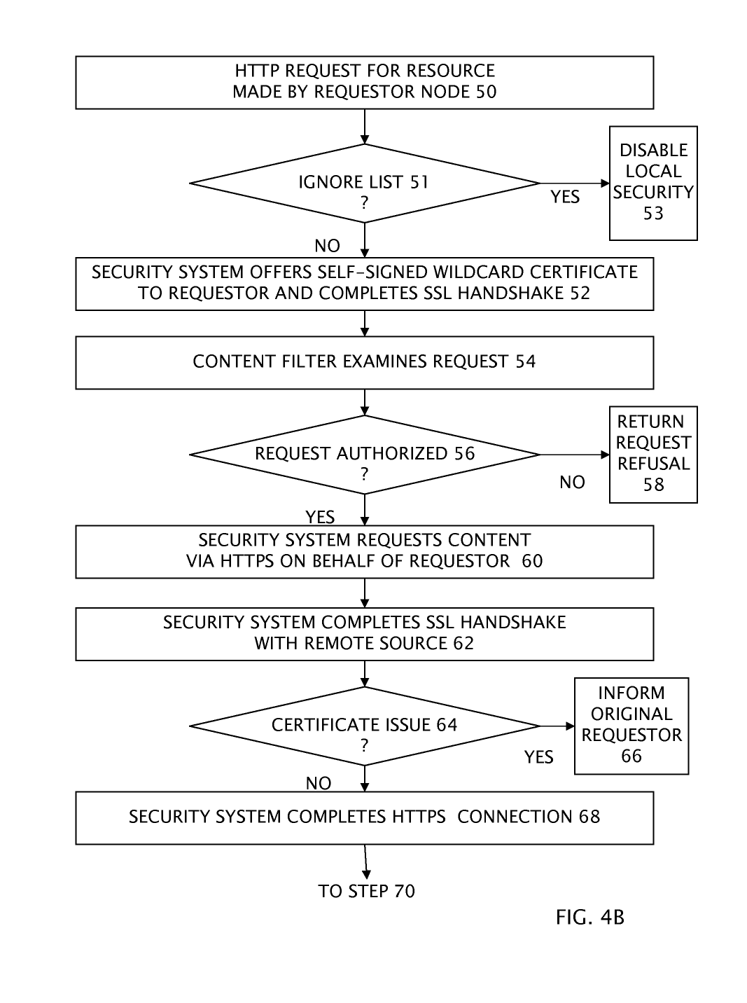

As will be explained below when referring to the process flow of FIG. 4, a wildcard certificate may be used in establishing the divided encryption link from the client computer 20 to the server 30. If a user intends to acquire information from the server, the first encryption-enabled connection 32 is formed from the client to the security system. Then, the security system establishes the second encryption-enabled connection 34 to the server via the Internet 28. There may be reasons for establishing the divided encryption link in a manner that is transparent to the client computers 20, 22 and 24. Here, the reasons relate primarily to security. Thus, from the perspective of the user of the client computer and with respect to the operations performed at the client computer, it may appear that there is a single encryption-enabled connection that provides the end-to-end link from the client 20 to the server 30. In this “transparent configuration,” neither end node receives information that evidences the “middleman” operations of the security system. In a preferred embodiment, each client computer 20, 22, and 24 comprises a Trusted Root Certification Authorities certificate store 21, 23, and 25 respectively. The method of the invention comprises creating, distributing and installing self-signed private security system root certificates in each client computer.

The security system 18 includes a self-signed private security system wildcard certificate store 35, and a first decrypt/re-encrypt device 36 that operates on data exchanges over the first encryption-enabled connection 32. A similar device 38 operates upon exchanges via the second encryption-enabled connection 34. These two “devices” may be implemented in software. Between these devices is a content filter 40 for applying and enforcing security measures with respect to data being exchanged via the encryption-enabled connections 32 and 34. As is known in the art, there are a number of different approaches to providing content filtering. The approach that is used at the content filter 40 is not critical to the invention. One available approach is to provide text screening in which transmissions having certain words are blocked. Words may be added and removed from a list depending upon concerns relating to confidentiality or the degree to which the words are “objectionable. “In another approach, content filtering is based upon lists of sites that are always blocked or always allowed. In a particularly restrictive execution of this approach, access is blocked to all sites not on an approved list. As a third approach, packet filtering may be provided, so that individual data packets are examined and access may be blocked on the basis of rules restricting source addresses, destination addresses, port numbers, or data types. This identification of available approaches is not intended to be exhaustive. That is, other approaches are known and may be used.

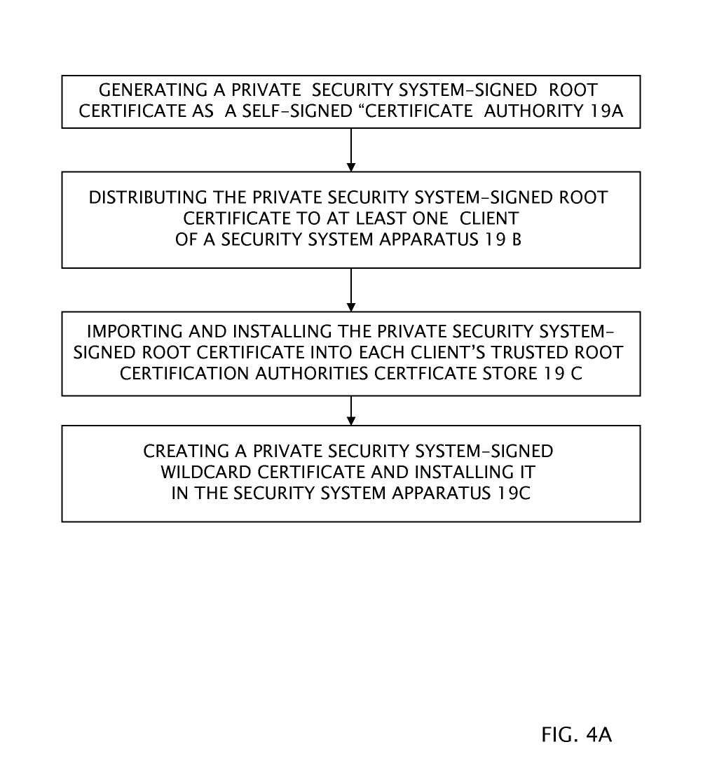

Referring now to FIG. 3, the content filter 40 of the security system 18 is shown as being connected to a rules base 42. The rules base may be a non-volatile storage device that lists the various rules to be enforced by the security system. The administrator of the security system has the ability to establish rules that are specific to individuals or specific to subsets of the total number of individuals to whom security is provided.

The security system 18 also includes an Instant Message log 44. Instant Messages that are exchanged within the intranet of the organization 26 or that are exchanged via the Internet 28 may be logged and/or content filtered, even if the Ns are encrypted when they reach the security system.

The first decrypt/re-encrypt device 36 is connected to an internal interface 46. The internal interface communicates with the client computers 20, 22 and 24. For example, the internal interface may be used in exchanges with the client computer 20 to establish the first encryption-enabled connection 32. Where the SSL protocol is used, the internal interface may provide wildcard SSL determination using a self-signed private security system wildcard certificate. The operations of the internal interface will depend upon the environment in which the security system is used, with the relevant factors including the encryption protocol being employed and the range of network nodes being supported.

The second decrypt/re-encrypt device 38 is connected to an external interface 48. As with the internal interface 46, the operations performed by the external interface will depend upon the environment in which the security system 18 is utilized. As one possibility, the external interface may function as an SSL agent to negotiate the second encryption-enabled connections 34 via the Internet 28.

FIG. 4A is a process flow of steps for configuring client computer nodes and a security system apparatus. At step 19a, the method comprises generating a private security system-signed root certificate as a self-signed “Cert Authority”. At step 19b, the method comprises distributing the private security system-signed root certificate to at least one client 20, 22, 24 of a security system apparatus. At step 19c, the method comprises importing and installing the private security system signed root certificate into each client's Trusted Root Certification Authorities certificate store 21, 23, 25. At step 19d, the method comprises creating a private security system-signed wildcard certificate 35 and installing it in the security system apparatus 18. The method comprises the steps following:
generating a private security system-signed root certificate as a self-signed “certificate authority;
distributing the private security system-signed root certificate to at least one client of a security system apparatus;
importing and installing the private security system-signed root certificate into each client's Trusted Root Certification Authorities certificate store; and
creating a private security system-signed wildcard certificate and installing said wildcard certificate in the security system apparatus.
   FIG. 4B is a process flow of steps for establishing the first and second encryption-enabled connections 32 and 34 of FIG. 2. Modifications of the process may be provided without diverging from the invention, as will be understood by a person skilled in the art. At step 50, a requester node, such as the client computer 20, issues a request for a secure connection in order to access a resource. In the illustrated embodiment, an HTTPS request is sent to the security system 18. The resource of interest to the client computer may be a storage of data at the server 30 or may be a service that is implemented through the server.

In step 51, a decision is made as to whether the request is identified on an “ignore list” or similar arrangement in which it is determined that the decryption and/or inspection process should be disregarded for certain content. As one possibility, if it is determined that the content is a bank transaction, an ISP may be configured to disable the local security, as indicated at step 53 of FIG. 4. It is possible to specify a list of servers, either by network address/range or by server name. The identification of a server name may be relevant to a portion, a pattern, or an exact match of the server name. Network address-based lookup techniques may be used, such as a reverse DNS lookup or the like. If it is determined by such means that the request should not be decrypted/inspected, the request can be forwarded in a manner that effectively disables the local security. However, other security measures will remain intact. On the other hand, if a negative response is determined at decision step 51, the process progresses to step 52.

At step 52, the security system 18 offers a self-signed private security system wildcard certificate to the requester and completes the SSL handshake. A digital certificate establishes credentials and includes the requester's public key that is used for encrypting messages and digital signatures, as well as the name of the service or server whose credentials it contains and the expiration date of such credentials. A typical digital certificate will have a specific name for the service or server that it represents. It is also allowed for part of the service or server name to be represented by an asterisk (“*”). In this case, the requester will accept the server or service name represented by the certificate as valid if: (1) the requested service or server name exactly matches the non-asterisk portion of the name provided by the certificate and (2) the asterisk, if replaced with the non-matching portion of the requested service or server name provided by the certificate, causes the service or server name provided by the certificate to exactly match the requested service or server name. It is possible to represent the entire name with a single asterisk, thereby indicating that this certificate may represent any service or server.

The security system 18 examines the request at step 54. The examination may be a comparison of the request parameters to the access rules stored within the rules base 42 of FIG. 3. A rule may be particular to a type of exchange (e.g., web page, Instant Message, or e-mail message) and may be particular to a particular individual or group of individuals. In the decision step 56, it is determined whether the request is authorized. Thus, for example, if the content filtering uses the approach in which access is enabled for only selected sites, the requested site is compared to the list of approved sites to determine whether there is a match. For situations in which a negative response is detected at decision step 56, the security system returns a request refusal to the requester, as indicated at step 58.

For situations in which it is determined that the request is authorized, the first encryption-enabled connection 32 is validated and the security system 18 initiates the process of establishing the second encryption-enabled connection 34. As indicated at step 60, the security system requests that the content from the source node (e.g., the server 30) be sent via a secure connection. The request is issued by the security system on behalf of the requester node (e.g., the client computer 20). As previously noted, some applications of the invention may enable the security system to function “transparently,” so that neither the requester node nor the source node is able to detect that the end-to-end link is not a single continuous secured connection.

At step 62, the SSL handshake with the remote source is completed. Any certificate issues are detected at step 64. If an issue exists, the requester node is optionally informed at step 66. On the other hand, if no certificate issues are detected, the HTTPS connection from the security system 18 to the server 30 is completed at step 68.

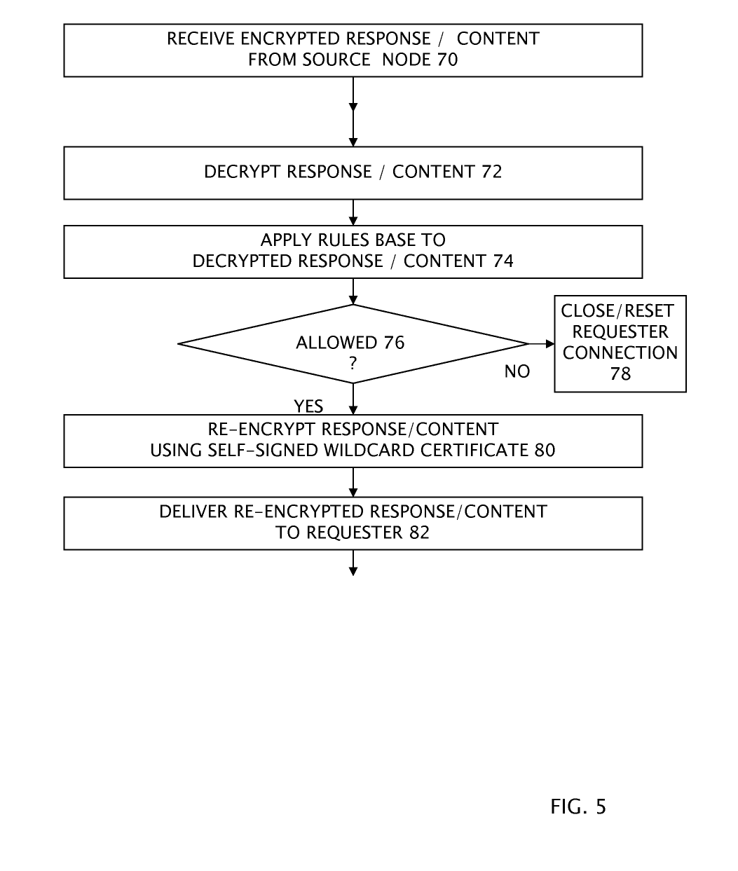

After the two encryption-enabled connections 32 and 34 are established, the secure data exchanges may be made between the requester node and the source node. FIG. 5 is a process flow of steps for execution during the data exchanges. The process will be described with respect to data flowing from the source node to the requester node, but the security system 18 of FIGS. 2 and 3 may be used to monitor information exiting the organization 26. Thus, the security system is able to prevent confidential information from being transmitted to an unauthorized outside source.

At step 70, the security system 18 receives an encrypted response or encrypted content from the source node, such as the server 30. The decrypt/re-encrypt device 38 of FIG. 3 uses the appropriate key to decrypt the response/content at step 72. The security system 18 is then able to apply the rules base to the decrypted response/content, as indicated at step 74. In decision step 76, a determination is made as to whether the data exchange is allowed. The detection process examines the data to detect Undesired Data. Virus checks and other safeguards may be executed. If the incoming data is e-mail, spam filtering may be provided. A negative response at the decision step 76 will result in execution of an enforcement step that is dictated by the rules base. For example, the requester connection may be reset or may be terminated at step 78. A detection of Spyware embedded within otherwise requested data may trigger an automatic connection termination. The user at the requester node may be notified of the reason for termination. Preferably, the specific actions which are executed upon detections that data exchanges are not allowed are adjustable by administrators of the security system 18.

If it is determined at decision step 76 that the data exchange is allowed, the response/content is re-encrypted at the other decrypt/re-encrypt device 36. In FIG. 5, the re-encryption is indicated at step 80 using the self-signed wildcard certificate. The re-encrypted response/content is delivered to the requester node at step 82. Applicants point out that in the absence of the private security system-signed root certificate distributed and installed in steps 19b and 19c, the client computer would object, warn, and discourage completion of delivery to requestor.

The steps of FIGS. 4 and 5 are applicable to providing content filtering of data exchanges in either direction. That is, in addition to blocking restricted transmissions from the Internet 28, the process may be used to block restricted transmissions from the organization 26 to external nodes via the Internet. Moreover, content filtering may be enforced for transmissions that are between two nodes of the intranet of the organization. For example, content filtering may be enforced for a data transmission from the first client computer 20 to the second client computer 22. In this case, the first encryption-enabled connection 32 is the same, but the second encryption-enabled connection 84 is from the security system 18 to the second client computer 22.

In another embodiment of the invention, detecting Spyware and other Undesired Data is less of a focus of the invention, since the main concern is monitoring Instant Messages. For an IM that is transmitted from the first client computer 20 to the second client computer 22, an encrypted IM may be transmitted over the first encryption-enabled connection 32 to the security system 18. The IM is decrypted by the device 36. If the security system 18 is programmed to provide content filtering, the content filter 40 and the rules base 42 are allowed to perform their intended purposes. Allowed IMs are then re-encrypted by the same device 36 for delivery to the second client computer 22 via the second encryption-enabled connection 84. In some applications, the content filtering may not be employed for internal transmissions of IMs, but archiving IMs may be a goal. Then, the Instant Message log 44 of FIG. 3 is employed.

For IMs that are transmitted to remote sites, the decrypting and re-encrypting are performed by the separate devices 36 and 38, as described with reference to FIGS. 4 and 5. Here, it is more likely that content filtering is a concern, as compared to IMs that remain within the network of the organization 26. However, while content filtering may be the focus in some uses of the invention, IM archiving may be additionally used for these IMs. In the preferred embodiment, the security system allows an administrator to select the features to be performed.

In addition to enabling archiving of the contents of IMs, the process may be applied to contents of encrypted e-mail messages and contents of encrypted web pages (HTTP). Thus, even if the rules base permits delivery of the contents, the contents of some or all of the transmissions may be archived.

As an alternative to the transparent mechanism described above, it is possible to perform inspection of encrypted content using a conventional HTTP proxy configuration. Typically, when an HTTP client is configured to proxy HTTPS using a conventional proxy server, the client may request secure data via the proxy server using the “CONNECT” request method. Unfortunately, in this configuration, the proxy server does not “understand” or interpret the content. However, it is possible to use the present invention to perform inspection in this situation. In the scenario, the client connects to the proxy server, which may or may not be the same device. When the “CONNECT” command is issued, the proxy server directs the request through the transparent gateway and the remainder of the process is the same as described above. This can be accomplished by placing the transparent gateway between the proxy server and the requested server.

The principal objective is to provide the user with the advantage of filtered content even through what is apparently an encrypted link. An alternative to deploying self-signed root certificates is redirecting via an authenticated secure proxy server as illustrated below:

Secure proxy via host replacement:

For a user requesting the url: http://mybank.com, any returned content with https:// links is replaced with a suffix in the hostname for a domain where we can legitimately have certificates.

For example, if we own the domain, mydomain.com, https://mybank.com would be replaced with https://mybank.com.secureproxy.mydomain.com

The proxy webserver converts the webpage for http://mybank.com:

```
<html><body>
  Welcome to my bank.
click <href a=http://pictures.mybank.com/pictures> here </a> to see
some pictures.
  click <href a=https://login.mybank.com/login> login </a> to login
  securely.
</body></html>
```

as follows:

```
<html><body>
  Welcome to my bank.
  click <href a=http://pictures.mybank.com/pictures> here </a> to
  see some pictures.
  click <href a=https://login.mybank.com.secureproxy.mydomain.com/
login> login </a> to login securely.
</body></html>
```

We can legitimately get a certificate for *.secureproxy.mydomain.com from a real authoratative certificate authority because we own mydomain.com, so when the user clicks on https://mybank.com.secureproxy.mydomain.com/ . . . . the certificate is valid (my dns also needs a wildcard entry for *.secureproxy.mydomain.com that resolves to my https proxy server with this certificate). The proxy server can now proxy the https connection from the client to the intended server (mybank.com) but will be able to decrypt the client requests for scanning. The requests would be re-encrypted and sent to the intended server. The response from the intended server would then be decrypted by the proxy, scanned (optionally), and re-encrypted to reply to the client.

It can be appreciated that the present invention can be easily distinguished from conventional methods by its redirection to a secure proxy having its own certificate rather than spoofing a user's desired target website or requiring the user to risk accepting a certificate with dubious provenance.

What is claimed is:

1. An apparatus for filtering content between a client within a local area network and a server coupled to the wide area network known as the Internet, comprising
a first network interface and
a second network interface,
a policy-driven pass through or proxy circuit,
a content filter,
a certificate store,
a webserver circuit,
a encryption/decryption circuit, and
a link replacement circuit,
wherein the policy-driven pass through or proxy circuit is coupled to the first network interface to receive a client request for a uniform resource locator, and wherein the webserver circuit is coupled to the first network interface and to the certificate store whereby a certificate is presented to a client to establish a first encrypted link.

2. The apparatus of claim 1 wherein the policy-driven pass through or proxy circuit is controlled by a protocol portion of a requested uniform resource locator (url).

3. The apparatus of claim 1 wherein the policy-driven pass through or proxy circuit is controlled by a list of trusted fully qualified domain names of a requested url.

4. The apparatus of claim 1 wherein the policy-driven pass through or proxy circuits is controlled by comparison of a list of dangerous fully qualified domain names with a requested url.

5. The apparatus of claim 1 wherein the encryption/decryption circuit is coupled to the content filter and to the first network interface and to the second network interface whereby traffic proxied between the first network interface and the second network interface is decrypted, filtered, and re-encrypted for transmission.

6. A method for operating the apparatus of claim 1 comprising: receiving a request from a client containing a request to a secure link, replacing the text of the requested resource with a request for a secure proxy, presenting a certificate from a Certificate Authority for the secure proxy, establishing a first encrypted link between the client and the secure proxy, and filtering, and re-encrypting the content for transmission if it passes the filter.

7. A method for preventing clients in a client server system from bypassing a proxy apparatus comprising: blocking https requests except through the secure proxy, configuring a domain name system server to direct external resource requests to the IP address of the proxy apparatus, and configuring each client browser to prevent users from typing certain links.

8. A method for determining if a proxy is interrupting a client server session comprising embedding a javascript program within a webpage to check if links within the webpage have been modified or manipulated.

9. A computer implemented method for applying security measures to network traffic comprising:
as a response to an HTTPS (Hypertext Transfer Protocol Secure) request to establish a secure connection between a first node and a second node, enabling a secure data exchange between said first node and said second node such that content of said data exchange is encrypted, including establishing a first encryption-enabled connection from said first node to a content filter and establishing a second encryption-enabled connection from said content filter to said second node, wherein establishing said second encryption-enabled connection includes issuing a request from said content filter to said second node on behalf of said first node;
decrypting content of web-based data received at said content filter via said second encryption-enabled connection;
applying said rules to determine whether said content includes content in violation of said rules;
using said determinations as a basis for enabling or inhibiting continued transmission of said content;
re-encrypting said content for which continued transmission is enabled; and
providing delivery of said re-encrypted content via said first encryption-enabled connection.

10. The method of claim 9 further comprising:
creating, distributing and installing self-signed private security system root certificates and a self-signed private security system wildcard certificate;
defining rules regarding permissible network transmissions, including enabling some said rules to be specific to individuals to whom said security measures are intended to protect.

11. The method of claim 9 further comprising:
within the first node, validating the self-signed private security system wildcard certificate with the self-signed private security system root certificate installed in the Trusted Root Certification Authorities certificate store.

12. The method of claim 11 wherein establishing said first and second encryption-enabled connections and decrypting said content are executed in a manner transparent to said first and second nodes, including using a self-signed wildcard certificate in establishing said first encryption-enabled connection.

13. The method of claim 11 wherein said first node is an HTTP client and said second node is a server that is accessed by said client via the global communications network referred to as the Internet.

14. The method of claim 11 wherein at least some said rules are specific to detecting Spyware.

15. The method of claim 11 wherein establishing said first encryption-enabled connection includes offering a private security system-signed wildcard certificate to said first node, said first node being a requester node with respect to said data exchange and being one of a plurality of nodes to which a private security system-signed root certificate had been distributed in anticipation of receiving a wildcard certificate that is unsigned by a third party official Certificate Authority (CA).

16. The method of claim 15 further comprising identifying certificate issues to said requester node if said certificate issues are detected while establishing said second encryption-enabled connection.

17. The method of claim 11 further comprising monitoring Instant Messages (IMs) and e-mail messages that are encrypted exchanges, said monitoring including decrypting and re-encrypting said IMs.

18. The method of claim 17 further comprising recording said IMs and e-mail messages following said decrypting.

19. The method of claim 17 wherein said monitoring includes detecting IMs exchanged among computers of a single business.

20. The method of claim 11 wherein defining said rules includes establishing an ignore list for selected said network transmissions, said decrypting and re-encrypting being disabled upon determining that a particular said network transmission is consistent with said ignore list.

21. A system for providing security for network traffic comprising:
a first input/output (I/O) interface;
a second I/O interface;
means for establishing a first encryption-enabled connection to a network node via said first I/O interface and for establishing a second encryption-enabled connection via said second I/O interface, said means for establishing being configured to utilize private security system-signed wildcard certificates to establish said first encryption-enabled connection and to provide both of said first and second encryption-enabled connections using Secure Sockets Layer protocol;
means for creating, distributing, and installing a private security system-signed Certificate Authority certificate to potential requestor nodes,
whereby a specific issue that may cause the requester node to generate an error or warning due to the fact that the wildcard certificate has not been signed by an official Certificate Authority (“CA”) is avoided,
a decryptor coupled to said second I/O interface to decrypt HTTP transmissions received via said second I/O interface;
a content filter operatively associated with said decryptor to filter Undesired Data that includes at least one of Spyware, Adware, viruses, or other undesirable content or communications, and to pass allowed content; and
a re-encryptor operatively associated with said content as re-encrypted HTTP transmissions filter to re-encrypt said allowed content and to direct said re-encrypted allowed content to said first I/O interface.

22. The system of claim 21 wherein said first and second I/O interfaces are merely two of a greater number of such I/O interfaces of said system.

23. The system of claim 21 wherein said content filter includes a library of Spyware signatures, each said Spyware signature being specific to an instance of Spyware.

24. The system of claim 23 wherein said first and second I/O interfaces are at a gateway of a network.

25. The system of claim 21 wherein said content filter is further configured to decrypt Instant Messages, said first and second I/O interfaces being connected within a network to receive said Instant Messages exchanged within said network.

26. The system of claim 25 further comprising memory for recording said Instant Messages that have been decrypted.

27. A method comprising the steps following:
generating a private security system-signed root certificate as a self-signed “certificate authority;
and
creating a private security system-signed wildcard certificate.

28. The method of claim 27 further comprising distributing the private security system-signed root certificate to at least one client of a security system apparatus.

29. The method of claim 27 further comprising importing and installing the private security system-signed root certificate into each client's Trusted Root Certification Authorities certificate store.

30. The method of claim 27 further comprising installing said wildcard certificate in the security system apparatus.
